(19) United States
(12) Patent Application Publication
(10) Pub. No.: US 2010/0118797 A1
(43) Pub. Date: May 13, 2010

(54) METHODS AND SYSTEMS USING FAST DL / UL SYNCHRONIZATION FOR MOBILE SYSTEMS

(75) Inventors: Jong Ro Park, San Ramon, CA (US); Chun Woo Lee, San Ramon, CA (US); Wan Ho Kim, Pleasanton, CA (US); Doo Seok Kim, Pleasanton, CA (US); Kyuong Cheol Oh, Danville, CA (US); Quanzhu Duan, Fremont, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/425,473

(22) Filed: Apr. 17, 2009

Related U.S. Application Data
(60) Provisional application No. 61/114,456, filed on Nov. 13, 2008.

(51) Int. Cl. H04W 72/14

(52) U.S. Cl. 370/329

(57) ABSTRACT

Certain embodiments provide techniques and apparatus that may allow for improvements in performance and power consumption in sleep and idle mode through fast DL and UL synchronization for wireless communications systems, such as Mobile WiMAX Systems.

### CLAIM OF PRIORITY

This patent application claims the benefit of priroity from U.S. Provisional Patent Application Ser. No. 61/114,456, entitled “Performance and Power Consumption Methods and Systems in Sleep and Idle Mode using Fast DL and UL Synchronization for Mobile WiMAX Systems” and filed Nov. 13, 2008, which is assigned to the assignee of this patent application and is fully incorporated herein by reference for all purposes.

### TECHNICAL FIELD

Certain embodiments of the present disclosure generally relate to wireless communication and, more particularly, to downlink (DL) and uplink (UL) synchronization for mobile WiMAX systems.

### SUMMARY

Certain embodiments provide a method for wireless communications. The method generally includes receiving a first downlink channel descriptor (DCD) message with a first set of DCD parameters, receiving a message indicating pending downlink (DL) traffic containing DL-MAP information, determining if the DL-MAP information matches the first set of DCD parameters, notifying a base station of a mismatch if the DL-MAP information does not match the first set of DCD parameters, and receiving a second DCD message with a second set of DCD parameters in response to the notification.

Certain embodiments provide a method for wireless communication. The method generally include tracking an availability of a mobile station (MS) in a low power state, determining if the MS has received a first DCD message with a current set of downlink channel descriptor (DCD) parameters, and sending the MS a second DCD message with the current set of DCD parameters, if the MS did not receive the first DCD message.

Certain embodiments provide method for wireless communication. The method generally includes tracking an availability of a mobile station (MS) in a low power state, determining if the MS has received a DCD message with a current set of downlink channel descriptor (DCD) parameters, and sending the MS data employing a default set of DCD parameters, if the MS did not receive the first DCD message.

Certain embodiments provide apparatus for wireless communications. The apparatus generally includes logic for receiving a first downlink channel descriptor (DCD) message with a first set of DCD parameters, logic for receiving a message indicating pending downlink (DL) traffic containing DL-MAP information, logic for determining if the DL-MAP information matches the first set of DCD parameters, logic for notifying a base station of a mismatch if the DL-MAP information does not match the first set of DCD parameters, and logic for receiving a second DCD message with a second set of DCD parameters in response to the notification.

Certain embodiments provide apparatus for wireless communication. The apparatus generally includes logic for tracking an availability of a mobile station (MS) in a low power state, logic for determining if the MS has received a first DCD message with a current set of downlink channel descriptor (DCD) parameters, and logic for sending the MS a second DCD message with the current set of DCD parameters, if the MS did not receive the first DCD message.

Certain embodiments provide apparatus for wireless communication. The apparatus generally includes logic for tracking an availability of a mobile station (MS) in a low power state, logic for determining if the MS has received a DCD message with a current set of downlink channel descriptor (DCD) parameters, and logic for sending the MS data employing a default set of DCD parameters, if the MS did not receive the first DCD message.

Certain embodiments provide apparatus for wireless communications. The apparatus generally includes means for receiving a first downlink channel descriptor (DCD) message with a first set of DCD parameters, means for receiving a message indicating pending downlink (DL) traffic containing DL-MAP information, means for determining if the DL-MAP information matches the first set of DCD parameters, means for notifying a base station of a mismatch if the DL-MAP information does not match the first set of DCD parameters, and means for receiving a second DCD message with a second set of DCD parameters in response to the notification.

Certain embodiments provide apparatus for wireless communication. The apparatus generally includes means for tracking an availability of a mobile station (MS) in a low power state, means for determining if the MS has received a first DCD message with a current set of downlink channel descriptor (DCD) parameters, and means for sending the MS a second DCD message with the current set of DCD parameters, if the MS did not receive the first DCD message.

Certain embodiments provide apparatus for wireless communication. The apparatus generally includes means for tracking an availability of a mobile station (MS) in a low power state, means for determining if the MS has received a DCD message with a current set of downlink channel descriptor (DCD) parameters, and means for sending the MS data employing a default set of DCD parameters, if the MS did not receive the first DCD message.

Certain embodiments provide computer-program product for wireless communications, comprising a computer readable medium having instructions stored thereon, the instructions being executable by one or more processors. The instructions generally include instructions for receiving a first downlink channel descriptor (DCD) message with a first set of DCD parameters, instructions for receiving a message indicating pending downlink (DL) traffic containing DL-MAP information, instructions for determining if the DL-MAP information matches the first set of DCD parameters, instructions for notifying a base station of a mismatch if the DL-MAP information does not match the first set of DCD parameters, and instructions for receiving a second DCD message with a second set of DCD parameters in response to the notification.

Certain embodiments provide computer-program product for wireless communications, comprising a computer readable medium having instructions stored thereon, the instructions being executable by one or more processors. The instructions generally include instructions for tracking an availability of a mobile station (MS) in a low power state, instructions for determining if the MS has received a first DCD message with a current set of downlink channel descriptor (DCD) parameters, and instructions for sending the MS a second DCD message with the current set of DCD parameters, if the MS did not receive the first DCD message.

Certain embodiments provide computer-program product for wireless communications, comprising a computer readable medium having instructions stored thereon, the instructions being executable by one or more processors. The instructions generally include instructions for tracking an availability of a mobile station (MS) in a low power state, instructions for determining if the MS has received a DCD message with a current set of downlink channel descriptor (DCD) parameters, and instructions for sending the MS data employing a default set of DCD parameters, if the MS did not receive the first DCD message.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device in accordance with certain embodiments of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology in accordance with certain embodiments of the present disclosure.

FIG. 4 illustrates example sleep mode operations utilizing power saving classes.

FIG. 5 illustrates an example exchange between a base station and a mobile station surrounding a period spent in a power saving mode.

FIG. 6 illustrates an example sleep exit, DL/UL synchronization, and data exchange.

FIG. 7 illustrates example operations for exiting sleep mode and performing a DL/UL synchronization.

FIG. 7A is a block diagram of means corresponding to the example operations of FIG. 7.

FIG. 8 illustrates an example sleep exit, DL/UL synchronization, and data exchange, in accordance with certain embodiments of the present disclosure.

FIG. 9 illustrates example operations for performing DL/UL synchronization.

FIG. 9A is a block diagram of means corresponding to the example operations of FIG. 9.

FIG. 10 illustrates an example DL/UL synchronization, sleep exit, and data exchange, in accordance with certain embodiments of the present disclosure.

FIG. 11 illustrates an example DL/UL transmission schedule, in accordance with certain embodiments of the present disclosure.

FIG. 12 illustrates example operations for transmitting data using a set of default DCD parameters.

FIG. 12A is a block diagram of means corresponding to the example operations of FIG. 12.

### DETAILED DESCRIPTION

Orthogonal frequency-division multiplexing (OFDM) and orthogonal frequency division multiple access (OFDMA) wireless communication systems under IEEE 802.16 use a network of base stations to communicate with wireless devices (i.e., mobile stations) registered for services in the systems based on the orthogonality of frequencies of multiple subcarriers and can be implemented to achieve a number of technical advantages for wideband wireless communications, such as resistance to multipath fading and interference. Each base station (BS) emits and receives radio frequency (RF) signals that convey data to and from the mobile stations.

For various reasons, such as a mobile station (MS) moving away from the area covered by one base station and entering the area covered by another, a handover (also known as a handoff) may be performed to transfer communication services (e.g., an ongoing call or data session) from one base station to another. Three handover methods are supported in IEEE 80216e-2005: Hard Handoff (HHO), Fast Base Station Switching (FBSS) and Macro Diversity Handover (MDHO). Of these, supporting HHO is mandatory, while FBSS and MDHO are two optional alternatives.

In current versions of the IEEE 802.16 standard, a BS may terminate an active state of the power saving class by sending a mobile traffic indication message (MOB_TRF-IND) that includes a positive indication for the sleep ID (SLPID) assigned to the power saving class. The MOB_TRF-IND message may be sent by the BS during a listening window to alert the MS of the appearance of a downlink (DL) traffic demand at the corresponding connections. After sending the MOB_TRF-IND, the BS may send data packets (PDUs) to the MS as the MS is assumed to be awake. The MS, however, may not be able to decode the PDUs. For example, if the MS does not have up-to-date DCD parameters that match the DL-MAP information included in the PDUs sent by the BS, the MS may not be able to decode the PDUs.

If there is a mismatch between the DCD parameters and the DL-MAP information included in the PDUs, the MS may discard subsequent PDUs until DCD parameters are updated and the MS receives PDU messages with matching DL-MAP information. As a result, the MS may lose all data packets transmitted before the DCD parameters and the DL-MAP information is synchronized resulting in a drop in data throughput.

In some cases, the MS may have to wait for 10 seconds or more before receiving a message including matching DCD parameters because the BS may not be aware of the situation. Moreover, the MS may experience increased power consumption even if the traffic indication message is negative as the MS may wait for the reception of an updated DCD/UCD message before entering a sleep state.

Embodiments of the present disclosure may provide a method and apparatus for detecting a mismatch between the DCD parameters last received by the MS 500 and the DL-MAP information found in transmitted PDUs and sending a DCD message to the MS 500 updating the DCD parameters prior to sending additional PDUs to the MS 500.

### Exemplary Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

One example of a communication system based on an orthogonal multiplexing scheme is a WiMAX system. WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX is based on OFDM and OFDMA and offers the full mobility of cellular networks at broadband speeds.

IEEE 802.16x is an emerging standard organization to define an air interface for fixed and mobile broadband wireless access (BWA) systems. These standards define at least four different physical layers (PHYs) and one media access control (MAC) layer. The OFDM and OFDMA physical layer of the four physical layers are the most popular in the fixed and mobile BWA areas respectively.

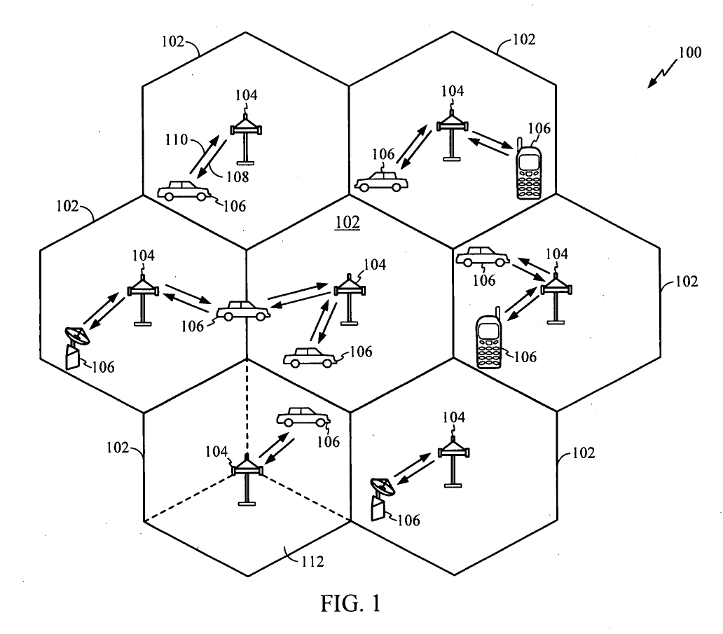

FIG. 1 illustrates an example of a wireless communication system 100 in which embodiments of the present disclosure may be employed. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers, etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

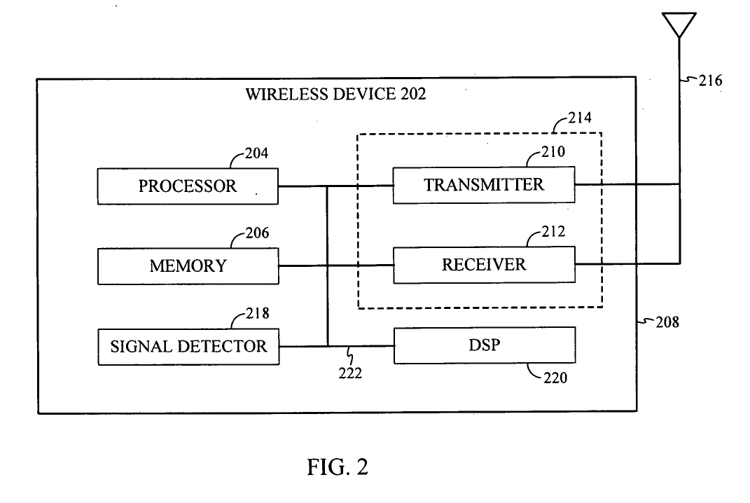

FIG. 2 illustrates various components that may be utilized in a wireless device 202 that may be employed within the wireless communication system 100. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy per pseudonoise (PN) chips, power spectral density and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

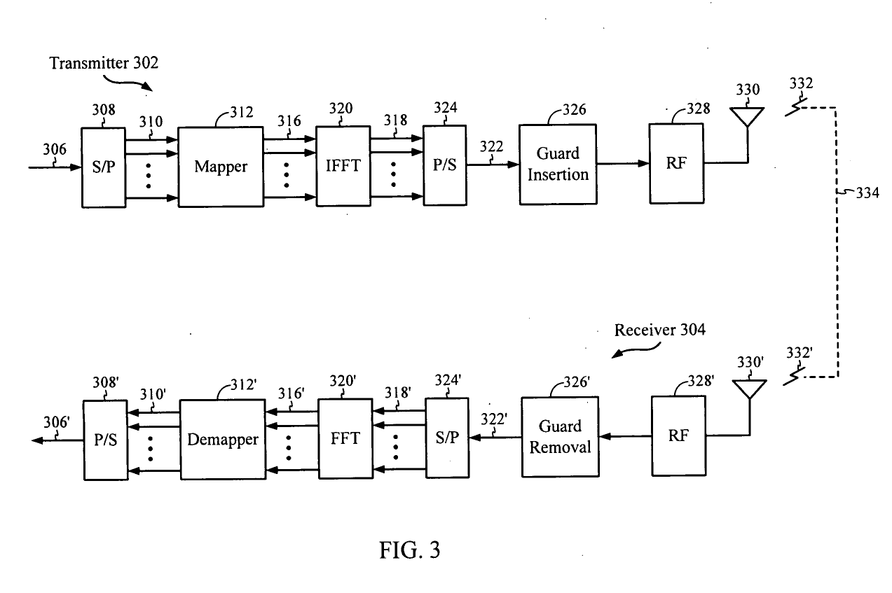

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Ns, is equal to Ncp (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless device 202 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312 thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

### Exemplary Fast DL/UL Synchronization for Mobile WiMAX Sytems

In current versions of the IEEE 802.16 standard, a BS may terminate an active state of the power saving class by sending a traffic indication message (MOB_TRF-IND) that includes a positive indication for the sleep ID (SLPID) assigned to the power saving class. The MOB_TRF-IND message may be sent by the BS during a listening window to alert the MS of the appearance of a downlink (DL) traffic demand at the corresponding connections. After sending the MOB_TRF-IND, the BS may send data packets (PDUs) to the MS as the MS is assumed to be awake. The MS, however, may not be able to decode the PDUs. For example, if the MS does not have up-to-date DCD parameters that match the DL-MAP information included in the PDUs sent by the BS, the MS may not be able to decode the PDUs. An example of the DCD parameters may include a burst profile indicating a modulation and coding scheme to be used.

If there is a mismatch between the DCD parameters and the DL-MAP information included in the PDUs, the MS may discard subsequent PDUs until DCD parameters are updated and the MS receives PDU messages with matching DL-MAP information. As a result, the MS may lose all data packets transmitted before the DCD parameters and the DL-MAP information is synchronized resulting in a drop in data throughput. In a worst-case scenario, the MS may have to wait for 10 seconds before receiving a message including matching DCD parameters because the BS may not be aware of the situation. Moreover, the MS may experience increased power consumption even if the traffic indication message is negative as the MS may wait for the reception of an updated DCD/UCD message before entering a sleep state.

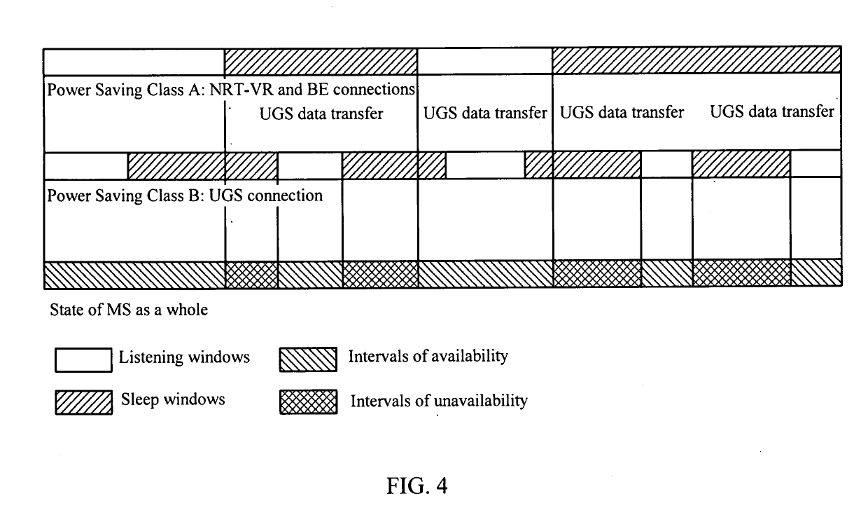

FIG. 4 illustrates example sleep mode operations observed by an MS utilizing multiple power saving classes. As illustrated, the MS may be unavailable to receive messages transmitted by a BS when a sleep window of each power saving class overlaps. During an unavailability interval, the MS may power down one or more physical operation components. As a result, the MS may buffer or drop MAC service data units (SDUs) during periods of unavailability. Accordingly, the BS may refrain from transmitting data to the MS during intervals of unavailability.

Conversely, the MS may be thought to be in an interval of availability during any interval in which sleep intervals do not overlap. During an availability interval, the BS may expect the MS to receive all DL transmissions. Additionally, the MS may be expected to monitor a DCD/UCD change count and a frame number of a DL-MAP physical synchronization field found in PDUs. If the DCD/UCD count is changed, the MS may remain available until it receives an updated DCD/UCD message.

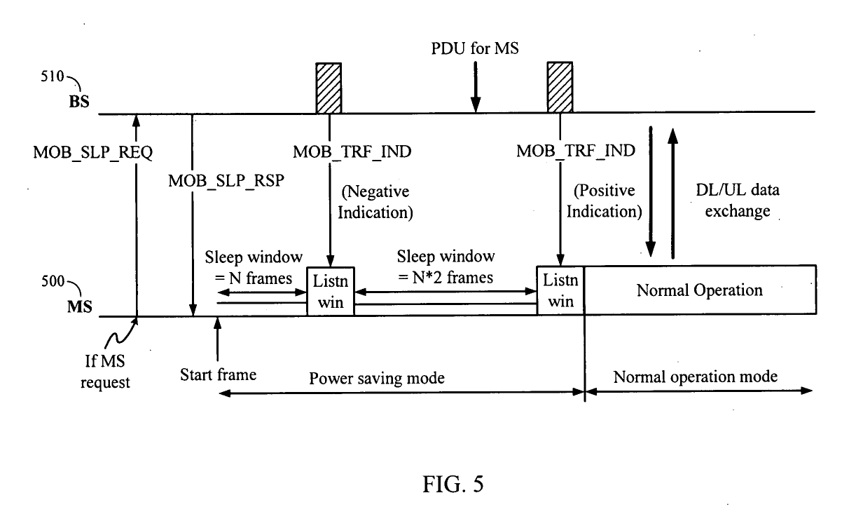

FIG. 5 illustrates example exchanges between a BS 510 and an MS 500 surrounding a period spent in a power saving mode. In the present example, the MS 500 is utilizing a power saving class (PSC) of type 1, which may be employed when the BS and MS share a best effort (BE) or non-real time variable rate (NRT-VR) connection.

As illustrated, the MS may request to enter a sleep mode by sending a mobile sleep request (MOB_SLP-REQ) to the BS. In certain embodiments, the MS may also utilize a Bandwidth (BW) request with a UL sleep control header to request a sleep mode. In response, the BS may grant the sleep request by sending a mobile sleep response (MOB_SLP-RSP) to the MS. However, certain embodiments may employ a DL sleep control extended sub-header in granting the sleep request.

During the exchange of the sleep request and sleep response, the MS and the BS may establish a schedule of sleep windows and listening windows defined by a PSC. The MS and BS may select the PSC based on a quality of service (QoS) associated with the one or more connections employed. In certain embodiments, the selected PSC may be defined, activated, or deactivated by one or more type, length, value (TLV) tuples transmitted in a ranging response (RNG-RSP) message.

During the scheduled listening windows, the MS may wake up to listen for and receive traffic indication messages (MOB_TRF_IND) messages from the BS. If the MOB_TRF_IND message indicates there is no traffic destined for the MS, the MS may return to sleep until the next scheduled listening interval. If, during a sleep window, the BS receives one or more PDUs destined for the MS, the subsequent MOB_TRF_IND message may give a positive indication of such.

After receiving and decoding a MOB_TRF_IND message indicating the presence of data traffic destined for the MS, the MS may deactivate the PSC and begin a DL/UL data exchange with the BS.

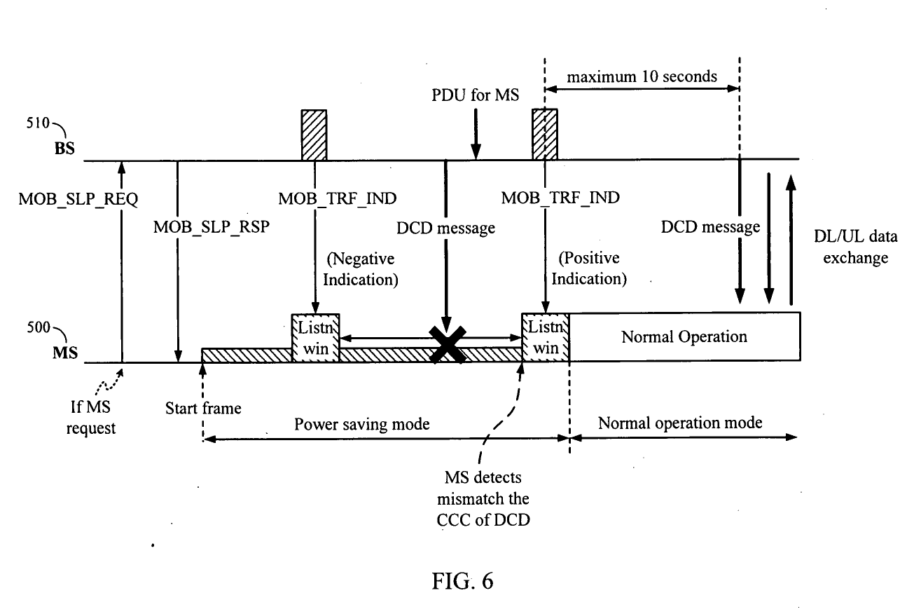

FIG. 6 illustrates example exchanges between a BS and an MS surrounding a period spent in a power saving mode. However, in certain instances, the BS may send a DCD message updating the DCD parameters while the MS is in a power savings mode. Consequently, the MS may not receive the DCD message. If the DCD parameters are updated while the MS is in a sleep window of the power savings mode, the MS may awake to a mismatch between the DCD parameters last received by the MS and the DL-MAP information found in transmitted PDUs.

Consequently, the MS may be unable to decode the PDUs. If the MS is unable to decode the PDUs, the MS may discard subsequent PDUs until DCD parameters are updated and the MS receives PDUs with matching DL-MAP information. In some instances, data exchange may be delayed as long as maximum DCD interval (e.g., 10 seconds) before the BS sends a DCD message updating the DCD parameters. Moreover, even if the traffic indication message is negative, the MS may experience increased power consumption as the MS may wait for the reception of an updated DCD/UCD message before returning to a sleep state.

Embodiments of the present disclosure may provide a method for detecting a mismatch between the DCD parameters last received by the MS and the DL-MAP information found in transmitted PDUs and synchronizing the DCD parameters last received by the MS with the DL-MAP information found in transmitted PDUs.

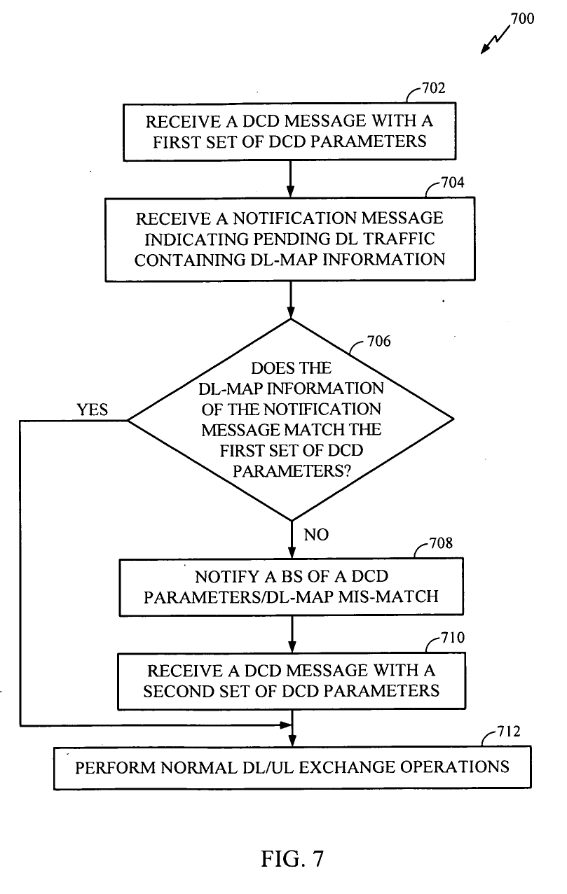

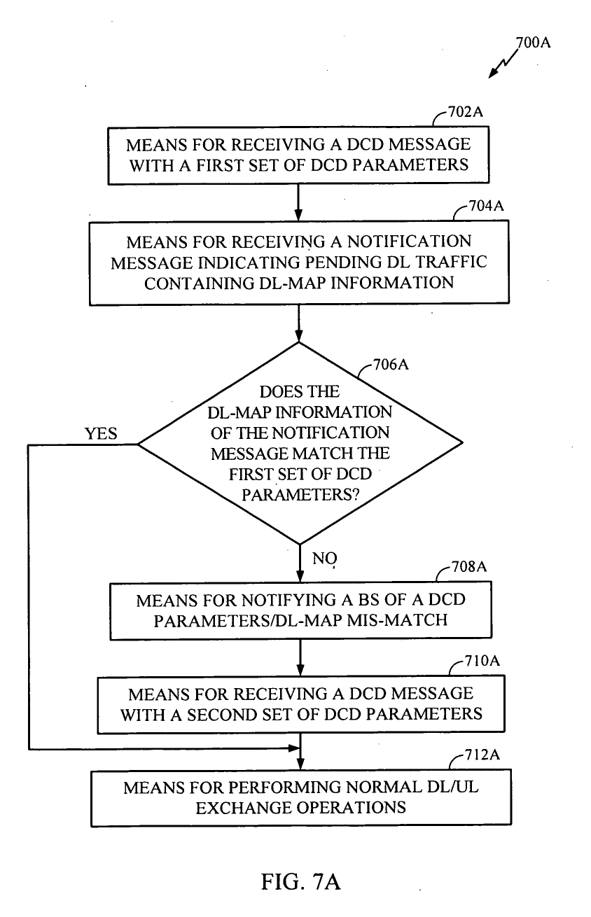

FIG. 7 illustrates example operations 700 which may be performed, for example by an MS 500, for detecting a mismatch between the DCD parameters last received by the MS and the DL-MAP information found in transmitted PDUs and synchronizing the DCD parameters received by the MS with the DL-MAP information.

Operations begin, at 702, with an MS receiving a DCD message with a first set of DCD parameters. In certain instances, the DCD message may be received prior to the MS entering a sleep mode. In other instances, the MS may receive the DCD message during a listening window of the sleep mode.

At 704, the MS may wake-up during a listening window and receive a notification message indicating pending DL traffic containing DL-MAP information. At 706, the MS may determine whether the DL-MAP information from the notification message matches the first set of DCD parameters received with the DCD message.

In certain embodiments, the MS may determine whether the DL-MAP information from the notification message matches the first set of DCD parameters received with the DCD message by examining a configuration change count (CCC) received from the BS during the listening window.

If the DL-MAP information of the notification message matches the first set of DCD parameters received with the DCD message, the MS may immediately begin normal DL/UL exchange operations, at 712, decoding the PDUs in accordance with the first set of DCD parameters.

In contrast, if the DL-MAP information of the notification message does not match the first set of DCD parameters received with the DCD message, the MS may notify a BS of the DCD parameters/DL-MAP information mismatch, at 708.

At 710, the MS may receive the DCD message including the second set of DCD parameters. With the updated parameter set, the MS may begin normal DL/UL operations, at 712, decoding the PDUs in accordance with the second set of DCD parameters.

In certain embodiments, the MS may notify the BS of the DCD parameters/DL-MAP information mismatch by sending a bandwidth request (BR) with a carrier-to-interference-plus-noise ratio (CINR) report header. If there is a mismatch, the MS may indicate such in a DCD change indication field in the CINR report header. For example, the DCD change indication field may be set to a value of 1.

If the BS receives this indication from the MS, the BS may send a DCD message through a fragmentable broadcast connection ID (CID) (e.g., 0xFFFD) or the basic CID of the MS, as soon as possible. Fragmentable broadcast CIDs may allow the BS to send the message to multiple MSs at one time. Consequently, the total number of messages sent by the BS may be reduced. In contrast, basic CIDs may limit the BS to transmitting a message to a single MS at one time. By sending a message to only a single MS, however, the BS may transmit at a higher bit rate. Basic CIDs may also reduce the bandwidth (BW) utilized for transmission of the message over the air.

Note, however, that under present versions of the IEEE 802.16 standard, DCD messages may only be transmitted by fragmentable broadcast CIDs. Additionally, the DCD message may only contain changed or updated TLV tuples, thereby reducing the utilized BW.

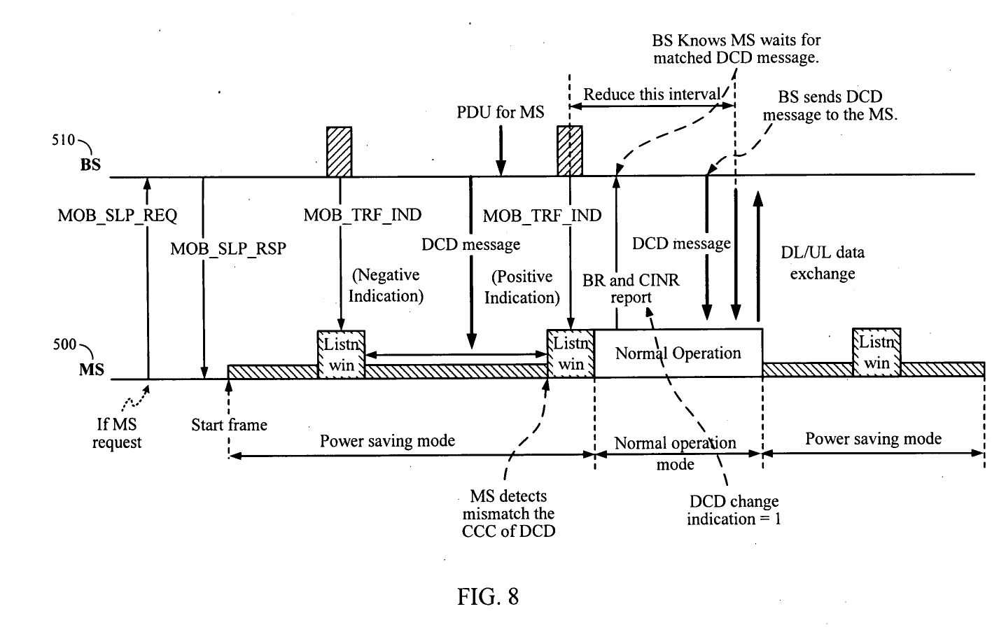

FIG. 8 illustrates example exchanges between a BS 510 and an MS 500 in accordance to certain embodiments of the present disclosure. For example, upon detecting the DL-MAP information of the notification message does not match the first set of DCD parameters received with the DCD message, the MS may send a bandwidth request (BR) with a CINR report indicating the mismatch. In response, the BS may send a DCD message with updated DCD parameters ahead of the normally scheduled DCD message transmission. After receiving the second set of DCD parameters, the MS may be able to properly decode the PDUs and the BS and the MS may begin normal DL/UL data exchange operations. Subsequently, after the DL/UL data exchange is complete, the MS may re-enter a power saving mode.

In certain embodiments, the BS may be able to determine whether or not the DCD parameters last received by the MS match with the DL-MAP information currently being sent by the BS. By tracking the availability of the MS and comparing that to the time DCD messages are sent, the BS may be able to determine whether the set of DCD parameters last received by the MS match the current set of DCD parameters. If the set of DCD parameters last received by the MS do not match the current set of DCD parameters, the BS may send a DCD message containing the updated DCD parameters even if the previous DCD message interval has not expired.

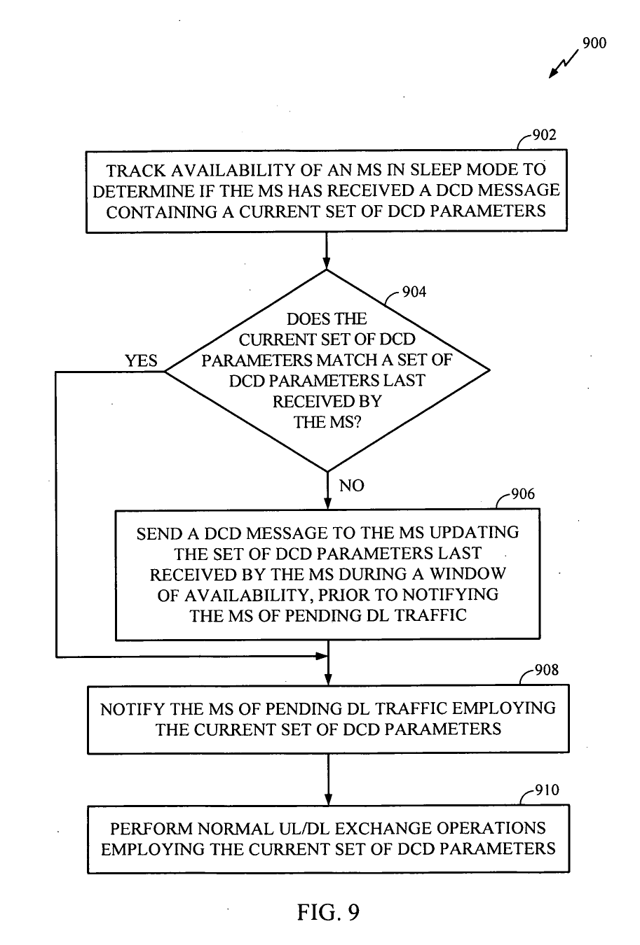

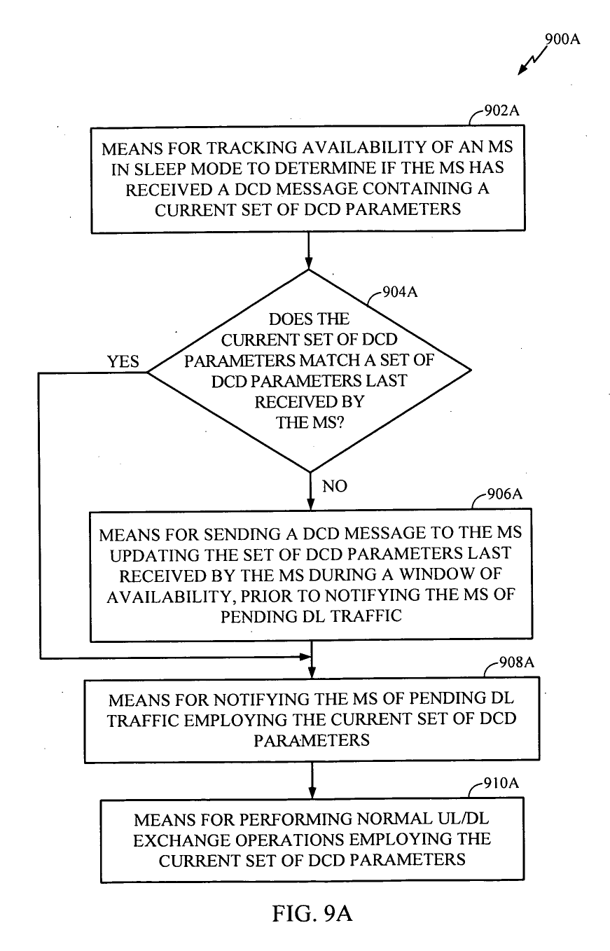

FIG. 9 illustrates example operations 900 which may be performed, for example by an BS 510, for detecting a mismatch between the DCD parameters last received by the MS 500 and a current set of DCD parameters and synchronizing the set of DCD parameters last received by the MS with the current set of DCD parameters.

Operations begin, at 902, with the BS tracking the availability of the MS in sleep mode. By tracking the availability periods, the BS may determine if the MS has received a DCD message containing a current set of DCD parameters.

At 904, the BS may determine if the current set of DCD parameters match the set of DCD parameters last received by the MS. If the current set of DCD parameters match, the set of DCD parameters last received by the MS, the BS may notify the MS of pending DL traffic in accordance with said DCD parameters, at 908.

If, however, the current set of DCD parameters do not match the set of DCD parameters last received by the MS, the BS may send a DCD message to the MS during a period of availability prior to notifying the MS of pending DL traffic. The DCD message may update the set of DCD parameters last received by the MS, synchronizing DCD parameters last received by the MS with the current set of DCD parameters.

After updating the set of DCD parameters last received by the MS, the BS, at 908, may notify the MS of pending DL traffic in accordance with the current set of DCD parameters. The BS may then perform normal UL/DL exchange operations, at 910, sending PDUs in accordance with the current set of DCD parameters.

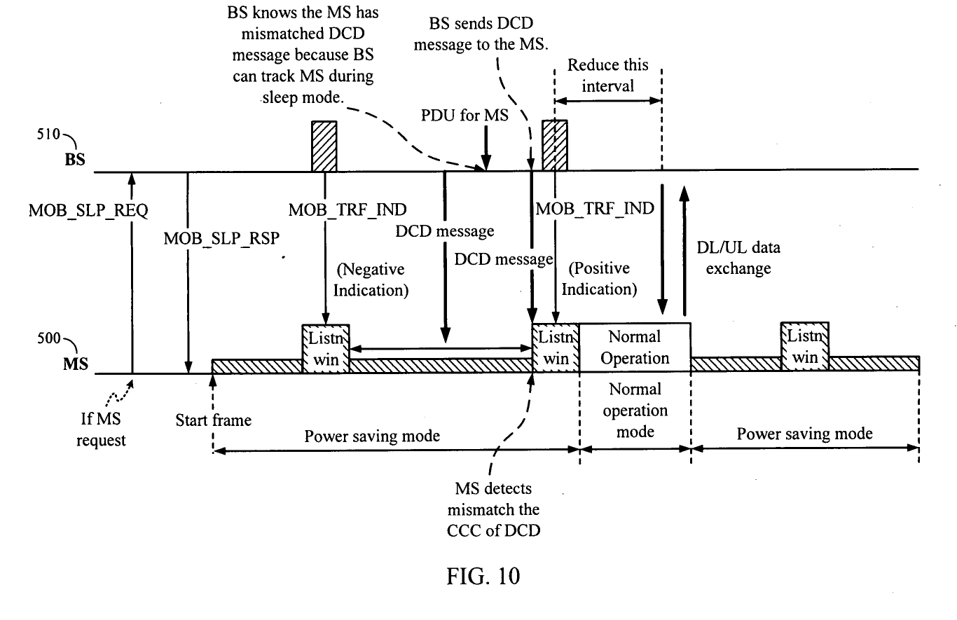

FIG. 10 illustrates example exchanges between a BS and an MS implementing embodiments of the present disclosure. For example, upon receiving a PDU destined for the MS, the BS may determine that the set of DCD parameters last received by the MS do not match the current set of DCD parameters. Accordingly, the BS may send a DCD message to the MS even if the previous DCD message interval has not expired. The DCD message may be identical to the DCD message sent by the BS but not received by the MS. In an effort to reduce utilized BW, the DCD message may include only the TLV tuples which have changed since the DCD message last received by the MS. As previously described, the DCD message may be transmitted either by fragmentable broadcast CID or the basic CID specific to the MS.

It should be noted, that although previously described embodiments have been described with reference to DCD messages, similar techniques and methods may also be applied with UCD messages.

Embodiments of the present disclosure may also enable a BS to proactively send a new UCD message during a paging listening interval preceding the expiration of the previous UCD message interval. This may enable each MS serviced by the BS to receive the new UCD parameters prior to the new UCD parameters going into effect.

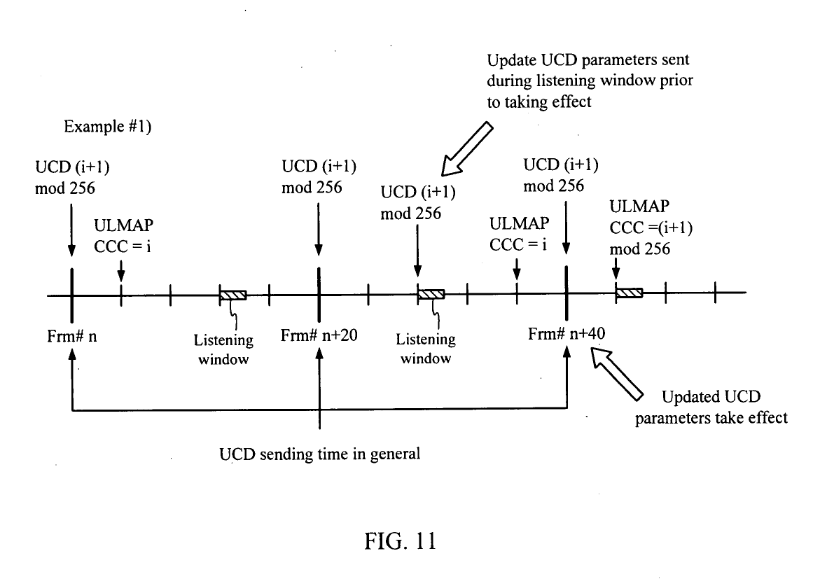

FIG. 11 illustrates an example UCD message being transmitted by an MS during a listening window preceding the start of the updated UCD parameters taking effect. In the present example, a UCD message interval may run 20 frames, for example from frame n to frame n+20. A subsequent UCD message interval may then run from frame n+20 to frame n+40 and so on. By sending a UCD message during the listening window preceding the frame n+40, the BS may receive the updated set of UCD parameters prior to the start of the next UCD message interval. Consequently, the BS may be prepared to decode the message sent during the first listening interval of the next UCD message interval (i.e., interval [n+40, n+60]).

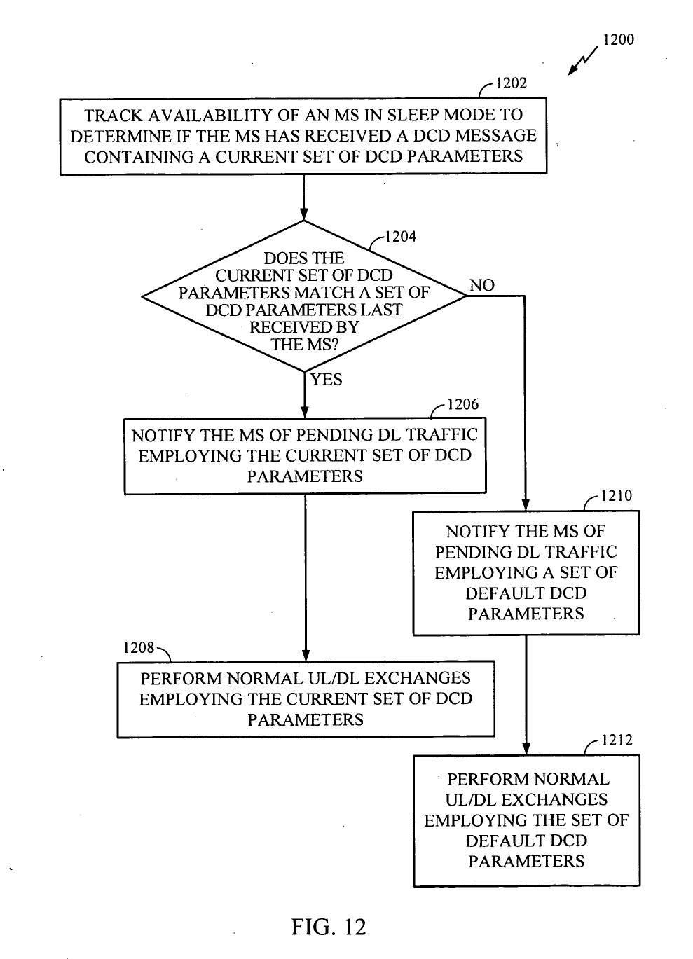

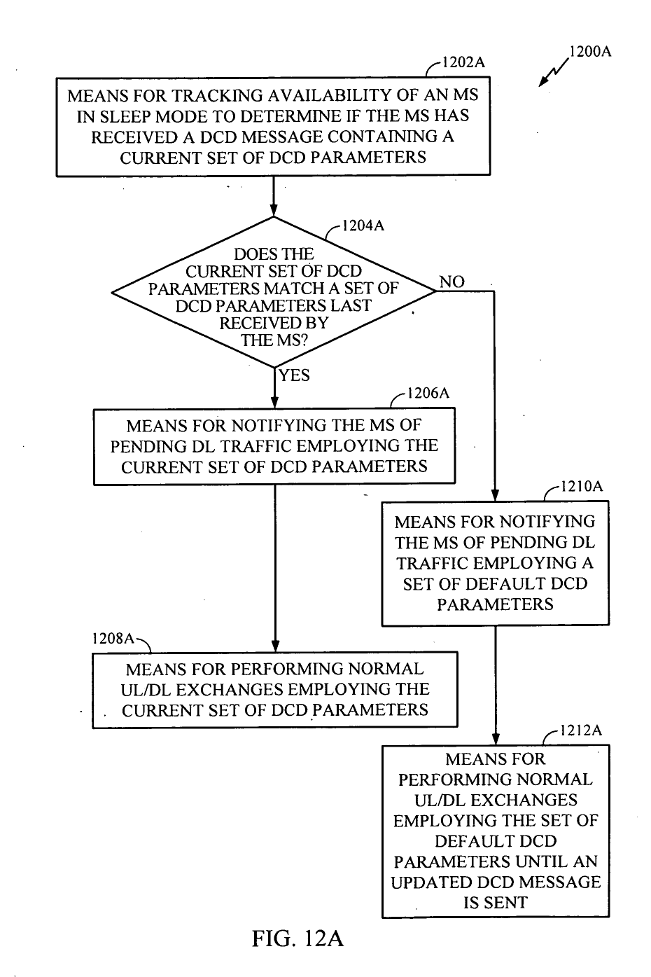

In certain embodiments, the BS may track the availability of the MS in a sleep mode and, after determining the MS has not received a DCD message containing a current set of DCD parameters, send data to the MS using a default set of DCD parameters until an updated DCD message is sent, as illustrated by operations 1200 in FIG. 12.

Operations 1200 begin, at 1202, with the BS tracking the availability of the MS in sleep mode. By tracking the availability periods, the BS may determine if the MS has received a DCD message containing a current set of DCD parameters.

At 1204, the BS may determine if the current set of DCD parameters match the set of DCD parameters last received by the MS. If the current set of DCD parameters match, the set of DCD parameters last received by the MS, the BS may notify the MS of pending DL traffic and perform normal UL/DL exchanges with the MS by employing the current set of DCD parameters, as illustrated at 1206 and 1208, respectively.

If, however, the current set of DCD parameters does not match the set of DCD parameters last received by the MS, the BS may notify the MS of pending DL traffic and perform normal UL/DL exchanges with the MS by employing a default set of DCD parameters, as illustrated at 1210 and 1212, respectively.

For example, the BS may notify the MS of pending DL traffic by sending a MOB_TRF-IND message wherein the default set of DCD parameters are indicated by setting a downlink interval usage code (DIUC) of the message to 0. Under current versions of the IEEE 802.16 standard, a DIUC equal to 0 may correspond to a quadrature phase shifting key (QPSK) modulation scheme and a convolutional coding (CC) scheme with a rate equal to ½.

By using the embodiments, as previously described, the time the MS may have to wait before receiving a message including matching DCD parameters may be reduced. Additionally, embodiments of the present disclosure may be applied to MSs entering idle mode as well as sleep mode. Instead of the BS sending a MOB_TRF-IND when there is pending traffic destined for the MS, the BS may send a message mobile paging advertisement message (MOB_PAG-ADV).

The various operations of methods described above may be performed by various hardware and/or software component(s) and/or module(s) corresponding to means-plus-function blocks illustrated in the Figures. Generally, where there are methods illustrated in Figures having corresponding counterpart means-plus-function Figures, the operation blocks correspond to means-plus-function blocks with similar numbering. For example, blocks 702-712 illustrated in FIG. 7 correspond to means-plus-function blocks 702A-712A illustrated in FIG. 7A. Similarly, blocks 902-910 and 1202-1212 illustrated in FIGS. 9 and 12, respectively, correspond to means-plus-function blocks 902A-910A and 1202A-1212A illustrated in FIGS. 9A and 12A, respectively.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein, such as those illustrated in the Figures, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to embodiments of the present disclosure, other and further embodiments of the disclosure may be devised without departing from the basic scope thereof, and the scope thereof is determined by the claims that follow.

What is claimed is:

1. A method for wireless communications, comprising:
receiving a first downlink channel descriptor (DCD) message with a first set of DCD parameters;
receiving a message indicating pending downlink (DL) traffic containing DL-MAP information;
determining if the DL-MAP information matches the first set of DCD parameters;
notifying a base station of a mismatch if the DL-MAP information does not match the first set of DCD parameters; and
receiving a second DCD message with a second set of DCD parameters in response to the notification.

2. The method of claim 1, wherein notifying the base station of the mismatch comprises sending a bandwidth request containing a carrier-to-interference-plus-noise ratio (CINR) report header indicating the DCD has changed.

3. The method of claim 1, wherein the second DCD message is received via a fragmentable broadcast connection ID.

4. The method of claim 1, wherein the message indicating pending DL traffic includes one of a mobile traffic indication (MOB_TRF-IND) message or a mobile paging advertisement (MOB_PAG-ADV) message.

5. A method for wireless communication, comprising:
tracking an availability of a mobile station (MS) in a low power state;
determining if the MS has received a first DCD message with a current set of downlink channel descriptor (DCD) parameters; and
sending the MS second information if the MS did not receive the first DCD message, wherein the second information includes one of a second DCD message with the current set of DCD parameters or data employing a default set of DCD parameters.

6. The method of claim 5, wherein determining if the MS has received the first DCD message comprises:
determining a time when the first DCD message was sent; and
comparing the time when the first DCD message was sent to the availability of the MS.

7. The method of claim 5, further comprising sending a mobile traffic indication (MOB_TRF-IND) message indicating the presence of downlink traffic.

8. The method of claim 5, further comprising sending a mobile paging advertisement (MOB_PAG-ADV) message indicating the presence of downlink traffic.

9. An apparatus for wireless communications, comprising:
logic for receiving a first downlink channel descriptor (DCD) message with a first set of DCD parameters;
logic for receiving a message indicating pending downlink (DL) traffic containing DL-MAP information;
logic for determining if the DL-MAP information matches the first set of DCD parameters;
logic for notifying a base station of a mismatch if the DL-MAP information does not match the first set of DCD parameters; and
logic for receiving a second DCD message with a second set of DCD parameters in response to the notification.

10. The apparatus of claim 9, wherein the logic for notifying the base station of the mismatch comprises sending a bandwidth request containing a carrier-to-interference-plus-noise ratio (CINR) report header indicating the DCD has changed.

11. The apparatus of claim 9, wherein the second DCD message is received via a fragmentable broadcast connection ID.

12. The apparatus of claim 9, wherein the message indicating pending DL traffic includes one of a mobile traffic indication (MOB_TRF-IND) message or a mobile paging advertisement (MOB_PAG-ADV) message.

13. An apparatus for wireless communication, comprising:
logic for tracking an availability of a mobile station (MS) in a low power state;
logic for determining if the MS has received a first DCD message with a current set of downlink channel descriptor (DCD) parameters; and
logic for sending the MS second information if the MS did not receive the first DCD message, wherein the second information includes one of a second DCD message with the current set of DCD parameters or data employing a default set of DCD parameters.

14. The apparatus of claim 13, wherein the logic for determining if the MS has received the first DCD message comprises:
logic for determining a time when the first DCD message was sent; and
logic for comparing the time when the first DCD message was sent to the availability of the MS.

15. The apparatus of claim 13, further comprising logic for sending a mobile traffic indication (MOB_TRF-IND) message indicating the presence of downlink traffic.

16. The apparatus of claim 13, further comprising logic for sending a mobile paging advertisement (MOB_PAG-ADV) message indicating the presence of downlink traffic.

17. An apparatus for wireless communications, comprising:
means for receiving a first downlink channel descriptor (DCD) message with a first set of DCD parameters;
means for receiving a message indicating pending downlink (DL) traffic containing DL-MAP information;
means for determining if the DL-MAP information matches the first set of DCD parameters;
means for notifying a base station of a mismatch if the DL-MAP information does not match the first set of DCD parameters; and
means for receiving a second DCD message with a second set of DCD parameters in response to the notification.

18. The apparatus of claim 17, wherein the means for notifying the base station of the mismatch comprises sending a bandwidth request containing a carrier-to-interference-plus-noise ratio (CINR) report header indicating the DCD has changed.

19. The apparatus of claim 17, wherein the second DCD message is received via a fragmentable broadcast connection ID.

20. The apparatus of claim 17, wherein the message indicating pending DL traffic includes one of a mobile traffic indication (MOB_TRF-IND) message or a mobile paging advertisement (MOB_PAG-ADV) message.

21. An apparatus for wireless communication, comprising:
means for tracking an availability of a mobile station (MS) in a low power state;
means for determining if the MS has received a first DCD message with a current set of downlink channel descriptor (DCD) parameters; and
means for sending the MS second information if the MS did not receive the first DCD message, wherein the second information includes one of a second DCD message with the current set of DCD parameters or data employing a default set of DCD parameters.

22. The apparatus of claim 21, wherein the means for determining if the MS has received the first DCD message comprises:
means for determining a time when the first DCD message was sent; and
means for comparing the time when the first DCD message was sent to the availability of the MS.

23. The apparatus of claim 21, further comprising means for sending a mobile traffic indication (MOB_TRF-IND) message indicating the presence of downlink traffic.

24. The apparatus of claim 21, further comprising means for sending a mobile paging advertisement (MOB_PAG-ADV) message indicating the presence of downlink traffic.

25. A computer-program product for wireless communications, comprising a computer readable medium having instructions stored thereon, the instructions being executable by one or more processors and the instructions comprising:
instructions for receiving a first downlink channel descriptor (DCD) message with a first set of DCD parameters;
instructions for receiving a message indicating pending downlink (DL) traffic containing DL-MAP information;
instructions for determining if the DL-MAP information matches the first set of DCD parameters;
instructions for notifying a base station of a mismatch if the DL-MAP information does not match the first set of DCD parameters; and
instructions for receiving a second DCD message with a second set of DCD parameters in response to the notification.

26. The computer-program product of claim 25, wherein the instructions for notifying the base station of the mismatch comprise instructions for sending a bandwidth request containing a carrier-to-interference-plus-noise ratio (CINR) report header indicating the DCD has changed.

27. The computer-program product of claim 25, wherein the second DCD message is received via a fragmentable broadcast connection ID.

28. The computer-program product of claim 25, wherein the message indicating pending DL traffic includes one of a mobile traffic indication (MOB_TRF-IND) message or a mobile paging advertisement (MOB_PAG-ADV) message.

29. A computer-program product for wireless communications, comprising a computer readable medium having instructions stored thereon, the instructions being executable by one or more processors and the instructions comprising:
instructions for tracking an availability of a mobile station (MS) in a low power state;
instructions for determining if the MS has received a first DCD message with a current set of downlink channel descriptor (DCD) parameters; and
instructions for sending the MS second information if the MS did not receive the first DCD message, wherein the second information includes one of a second DCD message with the current set of DCD parameters or data employing a default set of DCD parameters.

30. The computer-program product of claim 29, wherein the instructions for determining if the MS has received the first DCD message comprise:
instructions for determining a time when the first DCD message was sent; and
instructions for comparing the time when the first DCD message was sent to the availability of the MS.

31. The computer-program product of claim 29, wherein the instructions further comprise instructions for sending a mobile traffic indication (MOB_TRF-IND) message indicating the presence of downlink traffic.

32. The computer-program product of claim 29, further comprising sending a mobile paging advertisement (MOB_PAG-ADV) message indicating the presence of downlink traffic.
